(19) United States
(12) Patent Application Publication
(10) Pub. No.: US 2010/0138884 A1
(43) Pub. Date: Jun. 3, 2010

(54) INTERACTIVE MEDIA CONTENT DELIVERY USING ENHANCED WIRELESS BACKCHANNEL COMMUNICATIONS

(75) Inventor: Erwin Lau, Yuen Long (CN)

Correspondence Address: ROPES & GRAY LLP, PATENT DOCKETING 39/361, 1211 AVENUE OF THE AMERICAS, NEW YORK, NY, 10036-8704, US

(73) Assignee: United Video Properties, Inc., Los Angeles, CA (US)

(21) Appl. No.: 12/621,722

(22) Filed: Nov. 19, 2009

Related U.S. Application Data
(63) Continuation of application No. 11/541,246, filed on Sep. 29, 2006, now abandoned.

(51) Int. Cl. H04N 7/173

(52) U.S. Cl. 725/104

(57) ABSTRACT

Systems and methods are provided for granting access rights to specific media processing equipment. Such access rights may be provided to specific media processing equipment using an interactive wireless device as a backchannel. The interactive wireless device may be operative to retrieve, from an entitlement key source, an entitlement key corresponding to programming of interest and provide that entitlement key to the media processing equipment, thereby enabling the media processing equipment to access the programming of interest.

### BACKGROUND OF THE DISCLOSURE

This invention relates to media content delivery systems, devices, and methods, and more particularly, to media content delivery using enhanced wireless backchannel communications that facilitate media content programming, control, and/or delivery.

Cable, satellite, and broadcast television systems, and other media content delivery systems may provide viewers with a wide range of programming and other media content. The programming is generally distributed by a media provider to user equipment over a communications path. The distributed programming may include limited access programming (e.g., pay-per-view programming) in which predetermined user equipment is permitted to access such programming. In order to permit predetermined user equipment to access limited access programming, particular systems or techniques are needed to grant access to only that predetermined user equipment.

Certain systems may have the ability to address specific user equipment. Both one-way and two-way communication systems between the media provider and user equipment may be capable of addressing specific user equipment. For example, in such systems, the distribution facility may provide “access rights” or an “entitlement key” directly to specific user equipment.

In two-way communication systems, when a user wishes to view a particular program requiring access rights or an entitlement key in order to be viewed, the following sequence may transpire. First, the user may select that program, and in response, data (e.g., a unique identifier for that selected program) may be provided from the user equipment to the media provider. The data may be provided upstream using, for example, the upstream portion of the two-way communications link included as part of the two-way communication system. The media provider may process that data and then provide access rights or an entitlement key to the user equipment. When the user equipment receives the entitlement key, the user may then be permitted to access (e.g., view or record) the program corresponding to the entitlement key.

In one-way communication systems capable of addressing specific user equipment, several different approaches may be used to instruct, for example, a distribution facility to provide access rights or an entitlement key to specific user equipment. One known approach may require a user to place a phone call in order to cause the distribution facility to provide the requisite entitlement key. Another known approach may implement use of a backchannel to provide data to, for example, a media provider. In this approach, after the data (e.g., unique identifier) is received via the backchannel, the entitlement key may be provided to the user equipment via the one-way communications link of the one-way communication system.

In contrast, although the foregoing systems have the ability to specifically address user equipment, systems exist that are not able to address specific user equipment. Such systems may include, for example, over-the-air or terrestrial systems and satellite systems. In such systems, a user may be required to call a customer service representative (CSR) to obtain an access code, which has to be manually entered into the user equipment. In another approach, after the user has placed a call to the CSR, the user may be required to place the telephone in close proximity to the user equipment so it can receive auditory access information which enables that user equipment to access desired programming. Clearly, requiring a user to call a CSR in order to obtain access rights to view desired programming is burdensome and time consuming for the user, especially when users are forced to wait for an available representative.

Certain over-the-air and satellite systems may be able to address specific user equipment, however, doing so introduces problems relating to their communication link bandwidth. Such systems may transmit a “message” over-the-air to all user equipment, the message containing information that enables a specified user equipment to access desired programming. Bandwidth available on the communication link for broadcasted programs may be reduced in proportion with the number of messages required for authorizing user equipment, thus potentially disrupting the broadcast of programming.

In view of the foregoing, there is a need to provide improved systems and methods for granting access rights to specific user equipment in media content delivery systems.

### SUMMARY OF THE DISCLOSURE

Systems and methods are provided for granting access rights to specific user equipment. Such access rights may be provided to specific user equipment using an interactive wireless device as a backchannel in accordance with the principles of the present invention. The interactive wireless device may be operative to communicate with both user equipment and an entitlement key source (which may be included with a media provider). Thus, in one embodiment, the interactive wireless device may provide data (e.g., a unique identifier corresponding to user-desired programming) to the entitlement key source, which may process that data and return an appropriate entitlement key to the interactive wireless device. As defined herein, an entitlement key represents a “black box” abstraction of an access right that enables media processing equipment to access limited-access media content. The interactive wireless device may then provide the entitlement key to specific user equipment, thereby enabling the user equipment to limited-access media content corresponding to the entitlement key.

Advantages realized using the interactive wireless device as a backchannel include the ability to provide access rights to specific user equipment in systems where the media provider is unable to address specific user equipment. Moreover, even in systems capable of addressing specific user equipment over a communication link that provides programming, using the interactive wireless device as a backchannel advantageously eliminates limitations on bandwidth that would otherwise be present in such systems.

### BRIEF DESCRIPTION OF THE DRAWINGS

FIG. 1 shows an illustrative grid program listings display arranged by time and channel;

FIG. 2 shows another display arrangement for providing media guidance;

FIG. 3 shows a generalized embodiment of illustrative user equipment device;

FIG. 4 shows a user equipment device being implemented in a system;

FIG. 5 illustrates a system for providing media content and data from a media provider in accordance with some aspects of the invention;

FIG. 6 is a flowchart illustrating a method of using an interactive wireless device to select an limited-access asset in accordance with the principles of the present invention;

FIG. 7 which shows an illustrative display on an interactive wireless in accordance with the principles of the present invention;

FIG. 8 shows a flowchart showing steps that may be taken when a user selects a limited-access asset using the media processing equipment in accordance with the principles of the present invention;

FIG. 9 shows an illustrative display that may be provided after a limited-access program is selected for viewing on media processing equipment; and

FIG. 10 shows another flowchart illustrating a method of using an interactive wireless device to select a limited-access asset in accordance with the principles of the present invention.

### DESCRIPTION OF THE INVENTION

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices (or wireless devices). On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

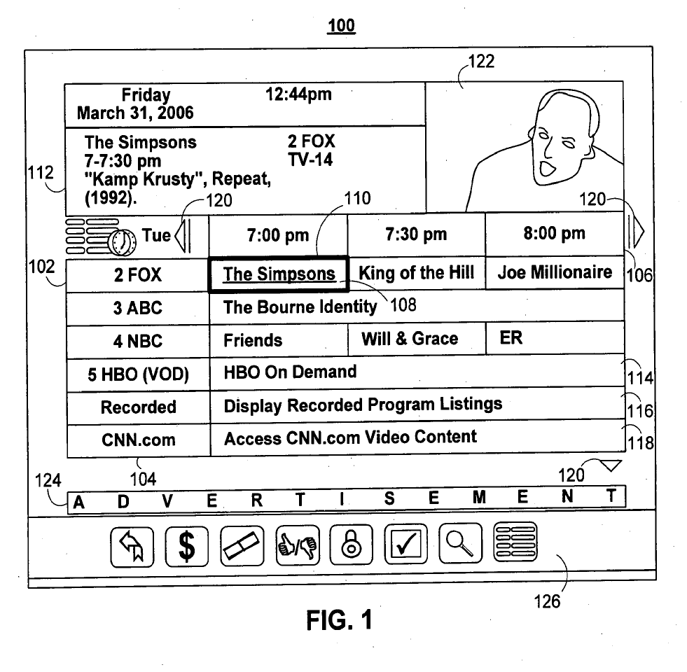

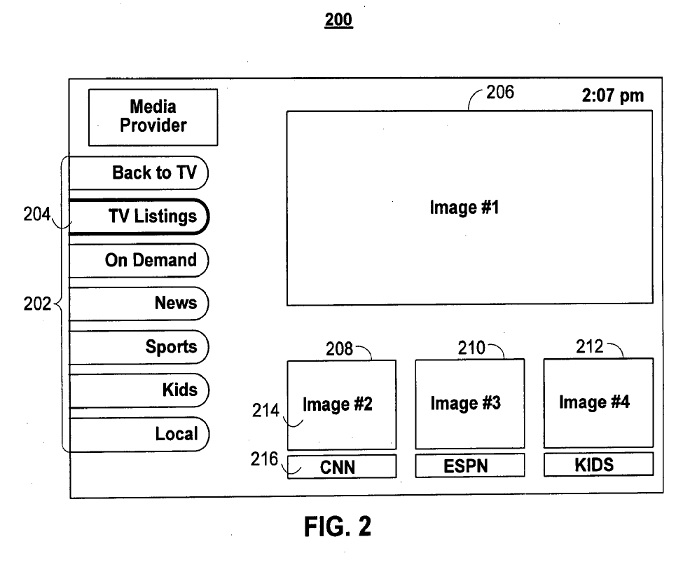

One of the functions of the media guidance application is to provide media listings and media information to users. FIGS. 1-2 show illustrative display screens that may be used to provide media guidance, and in particular media listings. The display screens shown in FIGS. 1, 2, 7 and 9 may be implemented on any suitable device or platform. While the displays of FIGS. 1, 2, 7 and 9 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND, THE SOPRANOS, and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g., FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in U.S. Pat. No. 6,564,378 to Satterfield et al. and U.S. Pat. No. 6,239,794 to Yuen et al., which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, U.S. Patent App. Pub. No. 2003/0110499 to Knudson et al., U.S. Pat. No. 6,177,931 to Alexander et al. and U.S. Pat. No. 6,388,714 to Schein et al., which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, record a program, enable series recording of a program, set program and/or channel as a favorite, purchase a program, or other features. Options available from a main menu display may include search options, VOD options, parental control options, access to various types of listing displays, subscribe to a premium service, edit a user's profile, access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

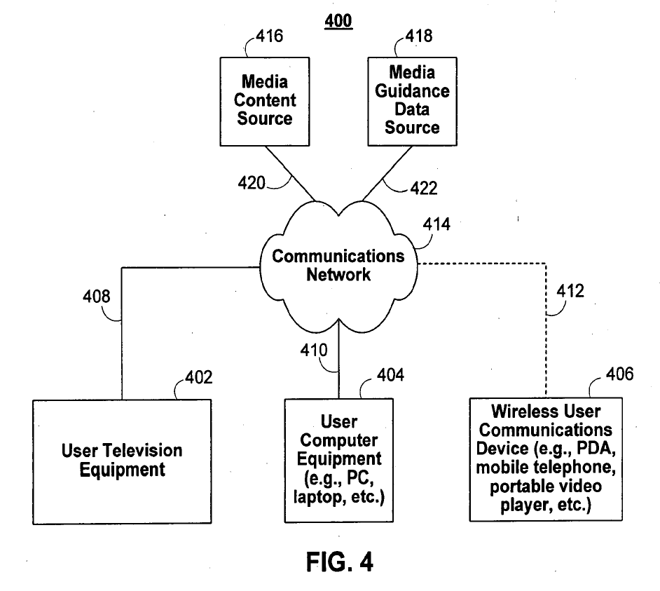

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in U.S. Patent App. Pub. No. 2005/0251827 to Ellis et al., U.S. patent application Ser. No. 09/437,304 to Boyer et al. (Attorney Docket UV-112), U.S. patent application Ser. No. 09/492,713 to Forrer et al. (Attorney Docket UV-151), and U.S. Patent App. Pub. No. 2002/0174430 to Ellis et al., which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, or other types of media that indicates to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, U.S. patent application Ser. No. 11/324,202 to Douglas Yates (Attorney Docket UV-402), which is hereby incorporated by reference herein in its entirety.

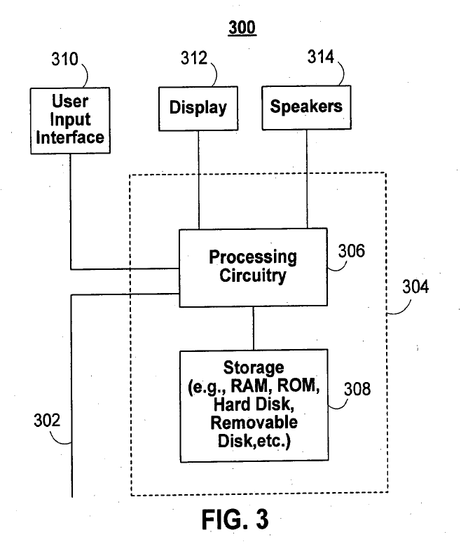

Users may access media content and the media guidance application (and its display screens described above and below) from one or more of their user equipment devices (i.e., media processing equipment). FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits may also be included as part of circuitry 304. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment, user equipment devices, or media processing equipment. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a trademark owned by Research In Motion Limited Corp. Paths 408, 410, and 412 may separately or together include one or more long range communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 that it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing. Communications between user devices 402 and 406 via paths 408 and 412 may be desired for the exchange of media content data such as media content titles, unique media content identifiers, entitlement keys (described in more detail below), or any other types of media content data described in connection with sources 416 and 418.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short range communication via wired or wireless paths. BLUETOOTH is a trademark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with U.S. patent application Ser. No. 09/332,244 to Ellis et al. (Attorney Docket UV-84), which is hereby incorporated by reference herein in its entirety.

Media guidance data source 418 may provide media guidance data, such as media listings, media-related information (e.g., broadcast times, broadcast channels, media titles, media descriptions) ratings information (e.g., parental control ratings, critic's ratings, etc.), genre or category information, actor information, logo data for broadcasters' or providers' logos, etc., media format (e.g., standard definition, high definition, etc.), advertisement information (e.g., text, images, media clips, etc.), on-demand information, permissions information (e.g., entitlement keys, unique media content identifiers), and other type of guidance data that is helpful for a user to navigate among, locate, and order desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel). Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in U.S. Patent App. Pub. No. 2005/0251827 to Ellis et al., which is hereby incorporated by reference herein in its entirety. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, U.S. Patent App. Pub. No. 2006/0031883 to Ellis et al., which is hereby incorporated by reference herein in its entirety.

In a third approach, users of user equipment devices inside and outside a home can use their media guidance application to communicate directly with media content source 416 to access media content. Specifically, within a home, users of user television equipment 404 and user computer equipment 406 may access the media guidance application to navigate among and locate desirable media content. Users may also access the media guidance application outside of the home using wireless user communications devices 402 to navigate among and locate desirable media content.

It will be appreciated that while the discussion of media content has focused on video content, the principles of media guidance can be applied to other types of media content or assets, such as music, images, interactive software games, any media that is digitized and suitable for electronic distribution, etc.

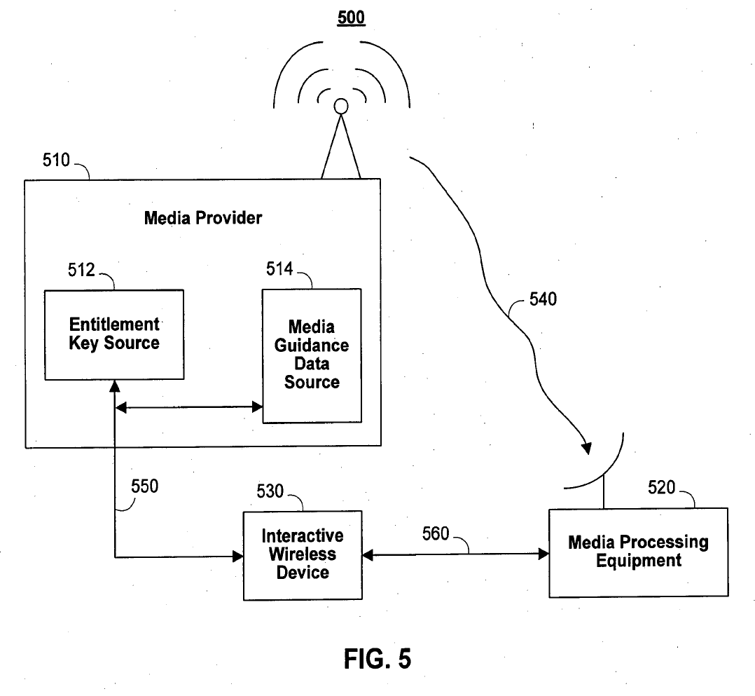

FIG. 5 shows an illustrative media distribution system 500 using an interactive wireless device as a backchannel in accordance with the principles of the present invention. System 500 includes media provider 510, entitlement key source 512, media processing equipment 520, and interactive wireless device 530. Interactive wireless device 530 may include personal digital assistants (PDAs), a mobile telephone, a portable video player, a portable music player, a portable gaming machine, a cellular phone, a hand held device, a wireless phone or other wireless devices. Media provider 510 may include a media guidance data source 514 (e.g., similar to source 418 of FIG. 4) and a media content source (not shown) (e.g., similar to source 416 of FIG. 4). Media guidance data may include television program listings, music selections, software listings, or any suitable type of media that may be available. Media provider 510 may provide “freely-accessible” media content which may be accessed without requiring media processing equipment 520 to have an entitlement key or other type of access right. Media provider 510 may provide limited-access content which may only be accessed by media processing equipment having access rights to such limited-access content. For example, media processing equipment may be granted access rights to limited-access content when it receives an entitlement key corresponding to the limited-access content.

Media processing equipment 520 may receive media guidance data and media content via path 540. Path 540 may include one or more long range communications paths, including, for example, a satellite path, a fiber-optic path, a cable path, a path that supports Internet communications (e.g., IPTV), free-space connections (e.g., for broadcast or other wireless signals), or any other suitable wired or wireless communications path or combination of such paths as described in connection with path 408 (FIG. 4).

As shown in FIG. 5, media provider 510 may provide content to media processing equipment 520 using an over-the-air type of unidirectional communications link (e.g., such as those used in terrestrial or satellite systems). Although FIG. 5 shows an over-the-air transmission scheme, it is understood that the principles of the present invention may be used in systems using other types of transmission schemes (e.g., one-way or two-way cable based media distribution systems that either cannot address specific media processing equipment or suffers from bandwidth problems even if it is able to address specific media processing equipment).

As defined herein, accessing refers to media processing equipment's ability to manipulate media content in a useful way. For example, useful manipulations of media content include recording the media content, displaying the media content, playing the media content, or executing the media content (e.g., when the media is an executable file). Accessing is not meant to include the act of receiving media content.

Limited-access content may include for example programming, pay-per-view, programming packages (e.g., sporting event broadcast tickets or television show series), pay-per-view television shows and movies, downloadable files, copy-protected music, copy-protected software, e-mail messages or attachments, etc.

Limited-access content may be encrypted or encoded with access restriction codes at, for example, media provider 510. For example, a public or private key encryption algorithm may be used to encrypt limited access content. Such encryption algorithms may include RSA, DES, 3DES, Blowfish, International Data Encryption Algorithm (IDEA), Software-optimized Encryption Algorithm (SEAL), RC4, or combination of the same. When limited-access content is encrypted, the entitlement key may include the decryption key needed to decrypt the limited-access content. In other embodiments, the limited-asset content may be restricted using methods other than encryption. For example, limited-access content may be encoded with instructions that prevent media processing equipment from accessing such limited-access content unless the media processing equipment device has the proper entitlement key.

Entitlement key source 512 may contain and provide entitlement keys for use in enabling media processing equipment 520 to access limited-access content. Entitlement key source 512 may be included as part of media provider 510 (as shown in FIG. 5) or it may be independent of (but preferably communicates with) media provider 510. Interacting with media provider 510 may enable entitlement key source 512 to maintain a database of up-to-date entitlement keys. For example, when new limited-access content becomes available, entitlement key source 512 may be updated accordingly. The entitlement key may be any sequence of numbers, digits, files, text-messages, e-mail, symbol, graphic image, picture, video, or other suitable form of data that may be used to enable access to a limited-access content. The entitlement key may also be set to expire or be invalidated after a pre-determined period of time or after a pre-determined number of accesses. The expiration or invalidation of the entitlement key may be desirable in systems where the limited-access content is only available for a pre-determined number of users or where the content is available for a pre-determined time period. The entitlement key may contain a counter which after being decremented or incremented a pre-determined number of times invalidates the entitlement key. Alternatively, an identifier (e.g., date and time) may be associated with the entitlement key which may used to invalidate the entitlement key.

In some embodiments, entitlement key source 512 may provide an entitlement key to interactive wireless device 530 over path 550 in response to receiving data (e.g., the selection of an asset and a random number corresponding to a selection of an asset) indicative of a selected limited-access asset from interactive wireless device 530. Note that reference herein to “an asset” refers to a single item of media content (e.g., a program). In some embodiments, when the interactive wireless device transmits the selection of the limited-access asset to the entitlement key source, a random number may also be transmitted. The random number may correspond to the selected asset and/or to a particular media processing equipment and/or interactive wireless device. The random number may be generated by and associated with a particular media processing equipment. As such, the random number may be unique to that particular media processing equipment and may be associated with more than one limited-access asset that may be selected using that particular equipment. The number may be random in that for any given asset, the number may change, for example, every ten minutes or each time the user selects an asset. The combination of the selected asset and random number associated with that selected asset may be used to ensure that the interactive wireless device receives an entitlement for only that selected asset and random number. “Tying” the entitlement key to the random number prevents unauthorized media processing equipment from using the entitlement key to access limited-access media content. Thus, in embodiments where a random number is provided to the entitlement key source, the entitlement key source may encode the entitlement key with the random number received from the interactive wireless device so that the equipment or device containing that number can use the entitlement key.

Path 550 may be a long range data path for enabling interactive wireless device 530 to send data to and receive data from entitlement key source 550 and/or media guidance data source 514 or media provider 510. Data path 550 may include General Packet Radio Service (GPRS), e-mail, text-messaging, WiFi, code division multiple access (CDMA) path, time division multiple access (TDMA) path, or any other suitable communications path or combinations of such that enable a wireless device to receive and send data.

In some embodiments, interactive wireless device 530 may receive media guidance data (e.g., media content asset listings). The media guidance data may by “synched” with the media guidance data provided to media processing equipment 520 so that, for example, the media content asset listings are substantially similar to those available on wireless device 530. In some embodiments, all or a portion of the media guidance data may be stored on wireless device 530. When storing a portion, it may be desirable for wireless device 530 to store limited-access assets as these assets may require that media processing equipment 520 have a corresponding entitlement key in order to access such assets.

The media content assets may be organized and displayed to a user on wireless device 530 in a similar fashion as that shown in FIG. 1. A user may browse through the assets and select a desired asset. Assuming the selected asset is a limited-access asset, wireless device 530 may provide the selection of the asset (or an identifier corresponding to the selected asset) to entitlement key source 512 or other processing source capable of receiving an asset selection at media provider 510. When the selection of the asset is received by entitlement key source 512, it may process the selection of the asset and provide an entitlement key via communications path 550 to wireless device 530. Allowing a user to select a limited-access asset using wireless device 530 is one way a user can initiate a process according to the present invention to obtain an entitlement key. A user may also select limited-access assets in a media guidance application being implemented on media processing equipment to initiate a process according to the present invention to obtain an entitlement key.

Media processing equipment 520 may be any equipment suitable for processing guidance data and content received from media provider 510 via path 540. For example, media processing equipment 520 may be user television equipment (such as equipment 402 of FIG. 4) or user computer equipment (such as equipment 404 of FIG. 4). The media guidance data may be processed such that media content assets are organized and displayed in a format, for example, similar to that shown in FIG. 1.

A user may browse and select at least one displayed asset listing for viewing. If the selected asset is freely accessible, media processing equipment 520 may immediately access (e.g., display) the selected asset with no further action. If the selected asset is a limited-access asset, media processing equipment 520 may require an entitlement key to access (e.g., display) the selected asset content. In such a situation, media processing equipment 520 may provide the selection of the asset (or a unique identifier corresponding to the selected asset) to wireless device 530 via short range data communications path 560. Wireless device 530 then may transfer the selection of the asset (or unique identifier thereof) to entitlement key source 512 via path 550.

Path 560 may be a short range data path for enabling media processing equipment 520 to provide the selected asset to and receive an entitlement key from wireless device 530. Data path 560 may include, for example, USB cables, IEEE 1394 cables, wireless paths (e.g., Bluetooth, infrared, IEEE 802-11x, etc.), or other short range communication via wired or wireless paths or any other suitable combinations of such that enable a media processing equipment to receive data from and send data to wireless device 530.

When wireless device 530 receives an entitlement key, it may provide it to media processing equipment via short range data communications path 560. If desired, wireless device 530 may store the entitlement key, for example, in memory. An entitlement key stored in memory may be retrieved and provided at a later time to media processing equipment 520. By storing the entitlement key a user may be able to select multiple entitlement keys for transmission to media processing equipment. Additionally, storing entitlement keys enables the wireless device to track the behavior of a particular user or display previously selected assets.

Media processing equipment 520 may receive and store the entitlement key in a memory. Media processing equipment 520 may organize a number of stored entitlement keys in a directory. The directory may allow a user to browse a number of stored entitlement keys, for example, by category or genre. When received, the entitlement key may be used to access the selected limited-access asset received from media provider 510 via path 540. For example, in some embodiments media processing equipment 520 may use a decryption algorithm (e.g., the same algorithm used by media provider 510 to encrypt the asset content) using the entitlement key as the decryption key. Alternatively, media processing equipment 520 may execute a number of instructions provided by the entitlement key to remove access restrictions from the selected limited asset.

The process of accessing a limited-access asset on media processing equipment 520 may be performed automatically. For example, after a user selects an asset on media processing equipment 520, media processing equipment 520 may automatically send the selection of the asset to the interactive wireless device. The interactive wireless device may automatically, in response to receiving the asset selection, provide the selection of the asset to entitlement key source 512 and receive the entitlement key. Interactive wireless device 530 may automatically, in response to receiving the entitlement key, provide the entitlement key to media processing equipment 520. Media processing equipment 520 may automatically, in response to receiving the entitlement key, remove access restrictions and access (e.g., display) the selected limited-access asset. The term automatically refers to the user not controlling or taking action to control the sequence of events.

In some embodiments, the media processing equipment may be configured to communicate with a pre-determined number of interactive wireless devices. Using such a configuration limits a particular user's media processing equipment to receive entitlement keys from only that pre-determined set of interactive wireless devices. The media processing equipment may be configured to limit the number of interactive wireless devices, for example, by storing one or more identifiers in the memory of the media processing equipment, where each identifier corresponds to a particular interactive wireless device. When communication with an interactive wireless device is attempted, the interactive wireless device may send its associated identifier to the media processing equipment. A search through the stored identifiers may be performed on the media processing equipment to find an identifier that corresponds to the identifier received from the interactive wireless device. If the identifiers match, the media processing equipment may “authorize” that interactive wireless device permit communication therebetween.

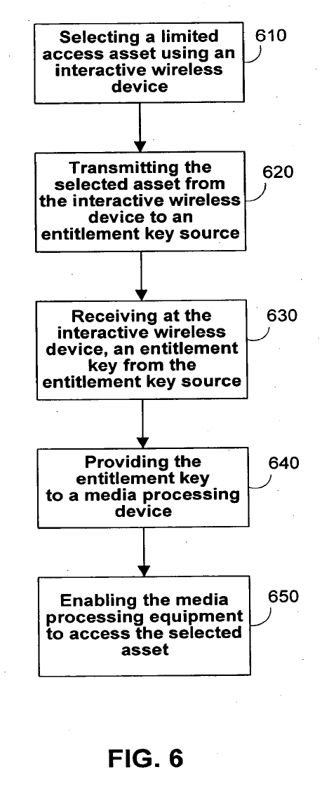

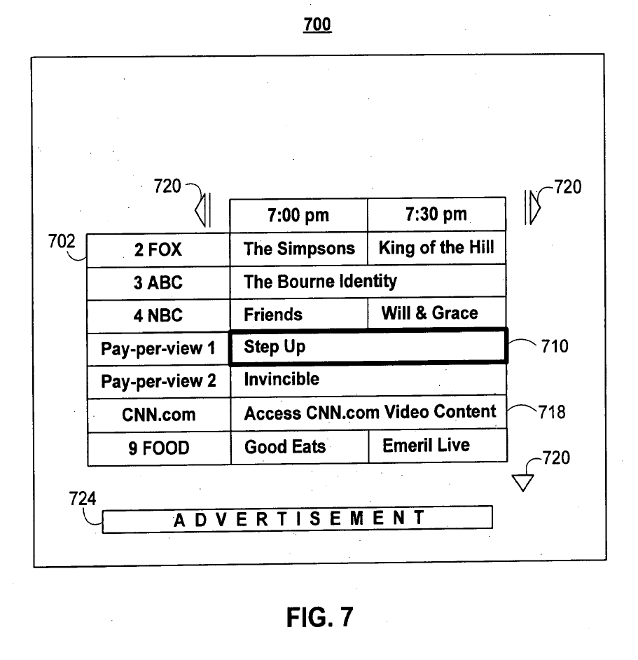

FIG. 6 is a flowchart illustrating a method of using an interactive wireless device to select an limited-access asset in accordance with the principles of the present invention. At step 610, a limited-access asset is selected on an interactive wireless device. Selecting a limited-access asset is demonstrated, for example, in FIG. 7, which shows an illustrative display 700 on an interactive wireless device (e.g., device 530 of FIG. 5). Display 700 may provide program listings 702 and may include the same or similar information and navigation options 720 as the display provided to a user on media processing equipment 402 (e.g., FIG. 5). Advertisement region 724 may also be the same or different than the advertisement region shown in connection with FIG. 1. As shown in display 700, navigable highlight region 710 is positioned on the limited-access program “Step Up,” shown as Pay-per-view channel 1.

Referring back to FIG. 6, at step 620 the selection of the limited-access asset is transmitted from the interactive wireless device to an entitlement key source. The transmission may include, for example, the title and/or unique ID and/or a random number of the selected limited-access asset. At step 630, an entitlement key may be received at the interactive wireless device from the entitlement key source (e.g., source 512 of FIG. 5). The transmission of the entitlement key from entitlement key source 512 to interactive wireless device 530 may be performed via, for example, communications path 550 of FIG. 5.

At step 640, the entitlement key is provided to the media processing equipment. The entitlement key may be provided to media processing equipment 520 via communications path 560 of FIG. 5. At step 650, the media processing equipment may be enabled to access the selected asst being provided by the media provider. This may be performed, for example, by using the entitlement key on media processing equipment (e.g., equipment 520) to remove access restrictions from the limited-access asset.

It is understood that the steps shown in FIG. 6 are merely illustrative and that additional steps may be added or existing steps may be modified.

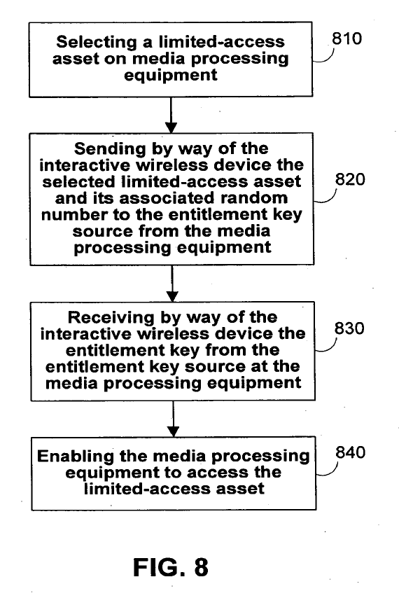

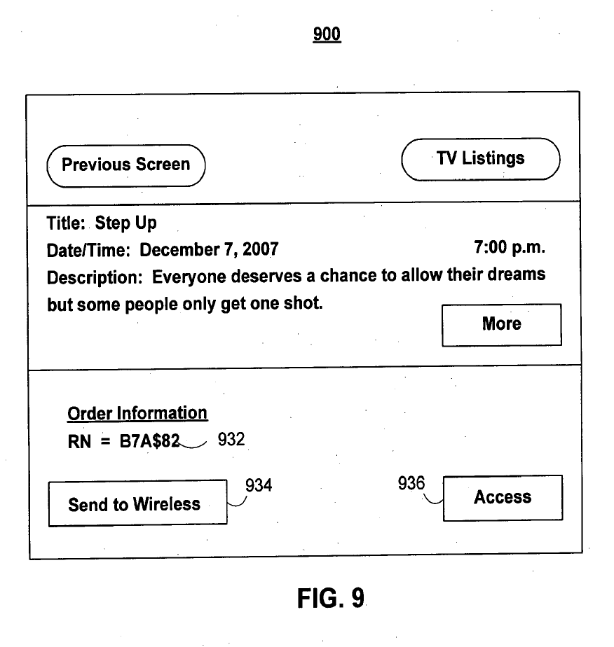

FIG. 8 shows a flowchart showing steps that may be taken when a user selects a limited-access asset using the media processing equipment in accordance with the principles of the present invention. At step 810, a limited-access asset is selected using the media processing equipment. FIG. 9 shows an illustrative display 900 that may be provided after a limited-access program is selected for viewing on media processing equipment. As shown, display 900 provides several options, most notably “send to wireless” option 934 and access “access” option 936. Also shown in display 900 is random number 932. Random number 932 may be the random number transmitted to entitlement key source via an interactive wireless device or the number generated by the media processing equipment (as discussed above).

If the media guidance application determines that the selected limited-access program does not have a entitlement key corresponding to the selected asset (e.g., Step Up) stored in the memory of the media processing equipment, “access” option 936 may be grayed out or not displayed. This may indicate to the user that the selected limited-access asset may not be accessed until an entitlement key is secured. If the media processing equipment does have an entitlement key corresponding to the selected asset, then access option 936 may be displayed (e.g., in a color green) or appear for the first time if it was not shown when no entitlement key was present.

At step 820, the media processing equipment may send, by way of the interactive wireless device, the selection of the limited-access asset and its associated random number to the entitlement key source. Referring back to display 900, when the user decides to order the selected limited-access program (assuming there is no entitlement key stored in the memory of the media processing equipment) the user may select “send to wireless” option 934. The selection of option 934 may result in having the selection of the limited-access asset and random number 932 automatically being sent to the interactive wireless device.

When the interactive wireless device receives the selection of the asset and random number, it may pass that data on to a entitlement key source. The entitlement key source may process the data and return an entitlement key to the interactive wireless device.

At step 830, the media processing equipment receives, by way of the interactive wireless device, the entitlement key from the entitlement key source.

At step 840, the media processing equipment is enabled to access the limited-access asset. Referring back to display 900 (FIG. 9), access option 936 may now be shown in a green color (or displayed for the first time) indicating that a corresponding entitlement key for the selected limited-access asset is available. In response to a user selecting access option 936, media processing equipment may apply the corresponding entitlement key to the selected limited-access asset to remove access restrictions and access the limited-access asset.

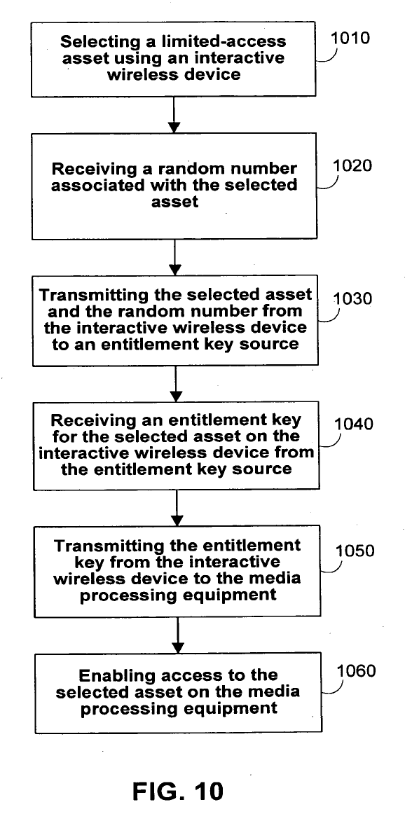

FIG. 10 shows another flowchart illustrating a method of using an interactive wireless device to select a limited-access asset in accordance with the principles of the present invention. At step 1010, a limited-access asset is selected using an interactive wireless device.

At step 1020, a random number associated with the selected asset is received by the interactive wireless device. The wireless device may receive the random number in a number of different ways. For example, in one embodiment, the interactive wireless device may receive the media processing equipment via, for example, path 560 of FIG. 5. In another embodiment, the random number may be manually entered by the user. In this embodiment, the user may have to enter the random number being displayed on the media processing equipment.

At step 1030, the selection of the limited-access asset is transmitted along with the random number from the interactive wireless device to the entitlement key source. At step 1040, the entitlement key for the selected limited-access asset may be received at the interactive wireless device from the entitlement key source. This step may be performed after entitlement key source 512 determines the corresponding entitlement key and transmits the entitlement key via communications path 550.

At step 1050, the entitlement key may be automatically transmitted from the interactive wireless device to the media processing equipment. At step 1060, the selected limited-access asset may be enabled for access on the media processing equipment. This may be performed for example, by using the entitlement key on media processing equipment 520 to remove access restrictions from the limited-access asset.

Although the aforementioned description relates to a system in which an entitlement key is provided to media processing equipment 520 using interactive wireless device 530 as a backchannel, one skilled in the art will appreciate that the entitlement key may be provided to media processing equipment 520 in any number of other ways. For example, a manual process for providing the entitlement key may include providing the entitlement key (in the form of a file) from media provider 510. A user at a computer may receive the entitlement key via e-mail, as an attachment or otherwise as text. The user may download the received entitlement key file onto a portable storage device (e.g., USB key, flashcard, smart media card, or any other form of portable storage). The user may then connect the portable storage device with the entitlement key to the media processing equipment. The media processing equipment may then download the file from the portable storage device into its memory. If the entitlement key is in the form of text (e.g., a sequence of alphanumeric numbers, symbols, or letters), then the user may manually input the text using the proper interactive screen on the media processing equipment to gain access to the limited-access asset.

In some embodiments, it may be desirable to have the file with the entitlement key configured to only work with a predetermined number of media processing equipment devices. An advantage of such a embodiment is that the user is prevented from applying the entitlement key in the file to unauthorized media processing equipment. To obtain such a configuration, the file may be associated with a reference identifier that needs be read by media processing equipment upon an attempted file access. Media processing equipment may read the reference identifier of the file after the file is downloaded from a portable storage device and prior to the application of the entitlement key in the file. Media processing equipment may then determine if the reference identifier read from the file corresponds with a previously programmed reference identifier in media processing equipment. When it is determined that the reference identifiers correspond, media processing equipment may apply the entitlement key in the file to the limited-access asset to remove access restrictions. If it is determined that the reference identifiers do not correspond, media processing equipment 520 may prompt the user with a message informing the user of the error and the file may be deleted from the memory.

Thus, systems and methods are provided for granting access rights to specific media processing equipment. It should be understood that the foregoing is only illustrative of the principles of the invention, and that the invention can be practiced by other than the described embodiments and aspects of the invention, which are presented for purposes of illustration and not of limitation, and the present invention is limited only by the claims which follow.

What is claimed is:

1. A system comprising:
a media provider for providing media and at least one entitlement key;
media processing equipment operative to receive the media from the media provider; and
a wireless communication device operative to receive an entitlement key based on a selected asset from the media provider and transmit the received entitlement key to the media processing equipment, the entitlement key enabling the media processing equipment to access the selected asset included in the media received from the media provider.

2. The system of claim 1, the wireless communication device operative to:
display a listing of assets;
allow a user to select one of the assets as the selected asset; and
transmit the selection of the asset to the media provider.

3. The system of claim 2, wherein the wireless communication device is further operative to transmit a random number to the media provider.

4. The system of claim 1, the media processing equipment operative to:
display a listing of assets;
allow a user to select one of the assets as the selected asset;
provide the selection of the asset to the wireless communication device, the wireless communication device operative to transmit the selected asset selection to the media provider.

5. The system of claim 1, the media processing equipment operative to:
receive the entitlement key from the wireless communication device; and
play the selected asset when the entitlement key is received by the media processing equipment.

6. The system of claim 1, wherein the media received by the media processing equipment comprises assets having access restriction, the media processing equipment operative to:
receive the entitlement key from the wireless communication device; and
use the entitlement key to remove the access restriction to the selected asset.

7. The system of claim 1, wherein the media provider distributes the media over a satellite communications link or a terrestrial over-the-air communications link.

8. The system of claim 1, wherein the media processing equipment receives the entitlement key independent of the media provider.

9. The system of claim 1, wherein the wireless communication device communicates with the media provider using a long range communications link.

10. The system of claim 1, wherein the wireless communication device communicates with the media processing equipment using a short range communications link.

11. The system of claim 1, wherein the wireless communication device functions as a multi-directional communication backchannel for enabling the media processing equipment to access the selected asset.

12. The system of claim 1, the wireless communication device operative to:
transmit data to and receive data from the media provider; and
at least provide data to the media processing equipment.

13. The system of claim 1, the media provider comprising:
an entitlement key provider for providing entitlement keys to the wireless communication device in response to receiving the selection of the asset from the wireless communications device.

14. The system of claim 1, wherein the wireless communications device is selected from the group consisting of a cellular phone, a hand held device, a personal digital assistant, and a wireless phone.

15. The system of claim 1, wherein the media processing equipment is selected from the group consisting of user television equipment, user computer equipment, and a set top box.

16. A method for authorizing access to media, the method comprising:
transmitting, from a first user equipment to a media provider, a selection of an asset;
receiving, at the first user equipment, an entitlement key from the media provider; and
providing the entitlement key to a second user equipment, the entitlement key enabling the second user equipment to access the asset.

17. The method of claim 16, further comprising:
transmitting a random number from the first user equipment to the media provider.

18. The method of claim 16, further comprising:
receiving, at the second user equipment, the entitlement key; and
playing the asset at the second user equipment when the entitlement key is received by the second user equipment.

19. The method of claim 16, further comprising:
using the first user equipment to select the asset.

20. The method of claim 16, further comprising:
using the second user equipment to select the asset; and
providing the selection of the asset to the first user equipment for transmission to the media provider.

21. The method of claim 16, wherein the first user equipment comprises a wireless communication device and the second user equipment comprises a media equipment device operative to receive media from the media provider.

22. The method of claim 16, wherein the enablement key expires after a predetermined period of time or after the asset is accessed.

23. The method of claim 16, further comprising providing the entitlement key to a third user equipment.

24. The method of claim 16, further comprising using a long range transmission scheme for the transmitting and the receiving.

25. The method of claim 16, further comprising using a short range transmission scheme for providing the entitlement key to the second user equipment.

26. The method of claim 16, wherein the media provider further comprises:
receiving the selection of the asset, wherein the selected asset comprises a unique identifier;
determining, from an asset database, an entitlement key corresponding to the unique identifier of the asset; and
transmitting the entitlement key corresponding to the unique identifier of the selected asset.

27. The method of claim 16, further comprising:
receiving, at the second user equipment, encrypted media from the media provider, the encrypted media including the selected asset;
receiving, at the second user equipment, the entitlement key;
decrypting the selected asset included in the received encrypted media using the entitlement key received at the second user equipment; and
accessing the decrypted selected asset.

28. The method of claim 16, further comprising:
receiving, at the second user equipment, media from the media provider, the media including access restriction packets that restrict access to assets included in the media;
receiving, at the second user equipment, the entitlement key;
disabling the access restriction packet for the selected asset included in the received media using the entitlement key received at the second user equipment; and
accessing the selected asset when the access restriction packet for the selected asset is disabled.

29. The method of claim 16, wherein the selected asset is a music asset, a programming asset, or software program asset.

30. The method of claim 16 further comprising:
receiving a plurality of television program listings at the first user equipment; and
selecting one of the television program listings as the selected asset on the first user equipment.

31. A system comprising:
a distribution facility for transmitting television programming over an over-the-air communications link;
user television equipment operative to receive the television programming over the over-the-air communications link; and
a wireless communication device operative to:
communicate with the user television equipment and a source that provides at least one entitlement key; and
authorize the user television equipment to display a program by providing an entitlement key corresponding to the program to the user television equipment.

32. The system of claim 31, the wireless communication device further operative to:
display a listing of television programs;
allow a user to select one of the displayed television program listings;
transmit data associated with the selected television program listing to the source; and
receive the entitlement key from the source in response to the source receiving the data associated with the selected television program listing.

33. The system of claim 31, wherein the distribution facility comprises the source.

34. The system of claim 31, wherein the distribution facility provides different tiers of television programming, and
wherein the entitlement key authorizes the user equipment to access one of the tiers of television programming.

35. The system of claim 31, wherein the distribution facility provides a plurality of television programming packages, and
wherein the entitlement key authorizes the user equipment to access one of the television programming packages.

36. A system comprising:
a wireless communication device configured to:
allow a user to select an asset from a plurality of asset listings,
receive a random number associated to the selected asset,
transmit the selection of the asset and the random number to an entitlement key source,
receive an entitlement key from the entitlement key source, and
transmit the entitlement key to a user equipment device;
the user equipment device operative to use the entitlement key to access the selected asset.

37. The system of claim 36, wherein the wireless communication device and the user equipment device are operative to receive the plurality of asset listings from the asset source.

38. The system of claim 36, wherein the wireless communication device uses a long range transmission scheme to transmit the selection of the asset and the random number to the entitlement key source.

39. The system of claim 36, wherein the wireless communication device uses a short range transmission scheme to transmit the entitlement key to the user equipment device.

40. The system of claim 36, wherein the user equipment device removes access restrictions from the selected asset by the application of the entitlement key.
